(19) United States
(12) Patent Application Publication
(10) Pub. No.: US 2026/0275943 A1
(43) Pub. Date: Sep. 17, 2026

(54) GAS FUEL INJECTION VALVE

(71) Applicant: DENSO CORPORATION, Kariya-city (JP)

(72) Inventor: Takashi FURUKAWA, Kariya-city (JP)

(21) Appl. No.: 19/669,225

(22) Filed: May 6, 2026

Related U.S. Application Data
(63) Continuation of application No. PCT/JP2024/036779, filed on Oct. 16, 2024.

(30) Foreign Application Priority Data
Nov. 10, 2023 (JP) 2023-192393

(51) Int. Cl. F02M 21/02

(52) U.S. Cl. CPC F02M 21/0269; F02M 21/0254

(57) ABSTRACT

A gas fuel injection valve includes: a main body that has an upstream-side opening formed through a partition for partitioning a fuel passage and a downstream-side opening formed at a downstream end portion of the fuel passage; a stationary core; a first valve that includes a first movable core and opens and closes the upstream-side opening; and a second valve that includes a second movable core. The second valve opens and closes the downstream-side opening. The first valve and the second valve are moved together toward a valve opening side when the first movable core is magnetically attracted to the stationary core in response to generation of a drive magnetic flux. After the first valve stops at a first lift position, the second movable core is magnetically attracted to the stationary core by the drive magnetic flux.

### CROSS REFERENCE TO RELATED APPLICATIONS

This application is a continuation application of International Patent Application No. PCT/JP2024/036779 filed on Oct. 16, 2024, which designated the U.S. and claims the benefit of priority from Japanese Patent Application No. 2023-192393 filed on Nov. 10, 2023. The entire disclosures of all of the above applications are incorporated herein by reference.

### TECHNICAL FIELD

The present disclosure relates to a gas fuel injection valve.

### BACKGROUND

As a gas fuel injection valve used for a direct-injection gas engine, for example, a gas metering valve has been proposed. The gas metering valve includes: a valve member that is configured to open an inflow opening of a gas chamber; and a shut-off valve that is disposed on a downstream side of the valve member, specifically disposed between the valve member and an outflow opening of the gas chamber. The valve member disposed on the upstream side is moved toward a valve opening side by a magnetic attractive force of an electromagnet, and the shut-off valve disposed on the downstream side is moved toward the valve opening side by a pressure balance after the opening of the valve member. Furthermore, when the valve member disposed on the upstream side is moved toward the valve opening side by the magnetic attractive force of the electromagnet, the shut-off valve is moved toward the valve opening side in mechanical linkage with the valve member.

### SUMMARY

According to the present disclosure, there is provided a gas fuel injection valve that is configured to inject a gas fuel. The gas fuel injection valve may include a main body, a stationary core, a first valve and a second valve. The main body may have: a fuel passage which is configured to conduct the gas fuel; an upstream-side opening which is formed through a partition that partitions the fuel passage into an upstream side and a downstream side; and a downstream-side opening which is formed at a downstream end portion of the fuel passage. The stationary core may be fixed to the main body. The first valve may include a first movable core which is opposed to the stationary core. The first valve may be configured to open and close the upstream-side opening by movement of the first movable core. The second valve may include a second movable core which is opposed to the stationary core. The second valve may be configured to open and close the downstream-side opening by movement of the second movable core. The first valve and the second valve may be configured to be moved together toward a valve opening side when the first movable core is magnetically attracted to the stationary core in response to generation of a drive magnetic flux. After the first valve stops at a first lift position, the second movable core may be magnetically attracted to the stationary core by the drive magnetic flux, and thereby the second valve may be moved from the first lift position to a second lift position at which a valve-element lift amount of the second valve is larger than a valve-element lift amount of the second valve measured at the first lift position.

### BRIEF DESCRIPTION OF DRAWINGS

The drawings described herein are for illustrative purposes only of selected embodiments and not all possible implementations, and are not intended to limit the scope of the present disclosure.

FIG. 1 is a longitudinal cross-sectional view of a fuel injection valve.

FIG. 2 is a transverse cross-sectional view of the fuel injection valve.

FIG. 3 is an explanatory diagram showing a relationship between a stationary core and respective movable cores.

FIG. 4 is a diagram for explaining an operation during the valve opening time of the fuel injection valve.

FIG. 5 is a diagram for explaining an operation during the valve opening time of the fuel injection valve.

FIG. 6 is a diagram for explaining the operation during the valve closing time of the fuel injection valve.

FIG. 7 is a longitudinal cross-sectional view showing a configuration example of the fuel injection valve.

FIG. 8 is a time chart showing changes in the lift amount and changes in the injection rate of a first valve and a second valve during opening and closing of the fuel injection valve.

### DETAILED DESCRIPTION

As a gas fuel injection valve used for a direct-injection gas engine, for example, a gas metering valve has been proposed. The gas metering valve includes: a valve member that is configured to open an inflow opening of a gas chamber; and a shut-off valve that is disposed on a downstream side of the valve member, specifically disposed between the valve member and an outflow opening of the gas chamber. The valve member disposed on the upstream side is moved toward a valve opening side by a magnetic attractive force of an electromagnet, and the shut-off valve disposed on the downstream side is moved toward the valve opening side by a pressure balance after the opening of the valve member. Furthermore, when the valve member disposed on the upstream side is moved toward the valve opening side by the magnetic attractive force of the electromagnet, the shut-off valve is moved toward the valve opening side in mechanical linkage with the valve member.

However, in the gas metering valve described above, in the configuration where the valve member disposed on the upstream side is opened by the magnetic attractive force of the electromagnet, and the shut-off valve disposed on the downstream side is opened by the pressure balance after the opening of the valve member, a delay occurs before the shut-off valve disposed on the downstream side opens after the valve member disposed on the upstream side opens. Therefore, there is a concern that in response to an injection command, a delay of the fuel injection will become large. Further, in the configuration in which the valve member disposed on the upstream side and the shut-off valve disposed on the downstream side are opened integrally, the lift amount of the valve member disposed on the upstream side and the lift amount of the shut-off valve disposed on the downstream side are equal to each other. Therefore, it becomes difficult to achieve a large flow rate of the gas fuel.

According to the present disclosure, there is provided a gas fuel injection valve that is configured to inject a gas fuel, the gas fuel injection valve including:
a main body that has:
   a fuel passage which is configured to conduct the gas fuel;
   an upstream-side opening which is formed through a partition that partitions the fuel passage into an upstream side and a downstream side; and
   a downstream-side opening which is formed at a downstream end portion of the fuel passage;
a stationary core that is fixed to the main body;
a first valve that includes a first movable core which is opposed to the stationary core, wherein the first valve is configured to open and close the upstream-side opening by movement of the first movable core; and
a second valve that includes a second movable core which is opposed to the stationary core, wherein the second valve is configured to open and close the downstream-side opening by movement of the second movable core, wherein:
the first valve and the second valve are configured to be moved together toward a valve opening side when the first movable core is magnetically attracted to the stationary core in response to generation of a drive magnetic flux; and
after the first valve stops at a first lift position, the second movable core is magnetically attracted to the stationary core by the drive magnetic flux, and thereby the second valve is moved from the first lift position to a second lift position at which a valve-element lift amount of the second valve is larger than a valve-element lift amount of the second valve measured at the first lift position.

The gas fuel injection valve having the above configuration includes: the first valve, which is configured to open and close the upstream-side opening formed through the partition that partitions the fuel passage into the upstream side and the downstream side; and the second valve, which is configured to open and close the downstream-side opening formed at the downstream end portion of the fuel passage. At the time of injecting the gas fuel, when the first movable core is magnetically attracted to the stationary core in response to the generation of the drive magnetic flux, the first valve and the second valve are moved together toward the valve opening side. After the first valve and the second valve stop at the first lift position, the second movable core is magnetically attracted to the stationary core by the drive magnetic flux, and thereby the second valve is moved to the second lift position at which the valve-element lift amount of the second valve is larger than the valve-element lift amount of the second valve measured at the first lift position.

Here, the second valve, which opens and closes the downstream-side opening (i.e., an injection hole), is moved together with the first valve toward the valve opening side, at the initial stage of valve opening by the magnetic attraction of the first movable core to the stationary core, and subsequently the second valve is moved alone further toward the valve opening side by the magnetic attraction of the second movable core to the stationary core. That is, the second valve performs the valve opening operation with high responsiveness, as the first movable core and the second movable core are magnetically attracted stepwise. Further, the second valve is lifted in the two stages, so that it is possible to increase the maximum opening degree of the downstream-side opening (the injection hole) as compared with lifting in a single-stage, and therefore achieve a large flow rate of the gas fuel having a large fuel volume. In this case, if an attempt is made to increase the maximum opening degree of the injection hole with the lifting in the single-stage, there is a concern that disadvantages, such as the need to increase the size of the solenoid coil for generating the drive magnetic flux, will arise. However, according to the present disclosure, such disadvantages can be suppressed. As a result, it is possible to increase the responsiveness at the time of fuel injection and achieve a large flow rate of the gas fuel.

The following describes one embodiment that implements a gas fuel injection valve according to the present disclosure with reference to the drawings. The gas fuel injection valve of the present embodiment is applicable to a direct-injection gas engine (internal combustion engine) that uses a gas fuel such as hydrogen, compressed natural gas (CNG) or liquefied natural gas (LNG), and the gas fuel is directly injected into a combustion chamber of the gas engine (hereinafter, also referred to as an engine combustion chamber) by the gas fuel injection valve. The gas engine is, for example, an in-vehicle engine. The fuel injection system, which includes the gas fuel injection valve in the present embodiment, is a so-called low-pressure direct injection system in which the gas fuel compressed to several MPa is injected from the fuel injection valve into the combustion chamber.

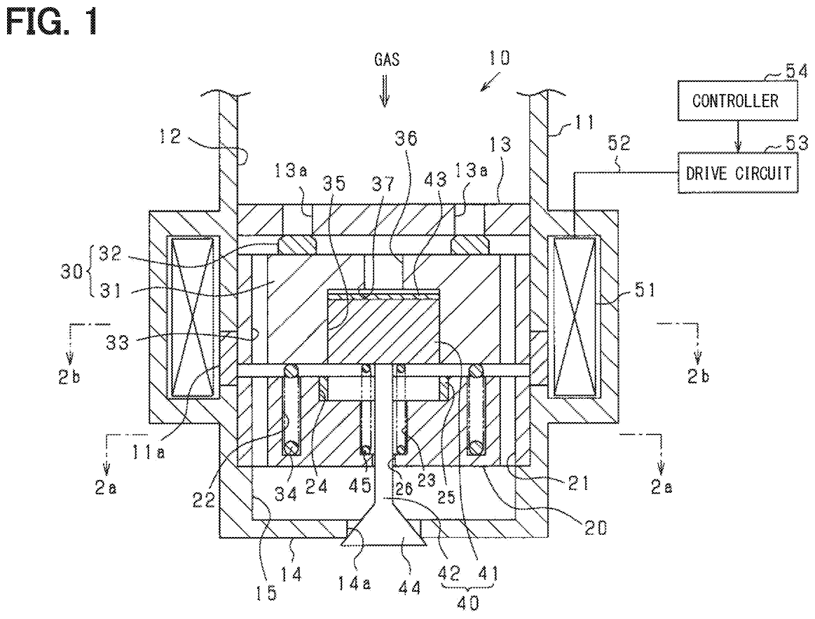

A configuration of the fuel injection valve 10 will be described with reference to FIG. 1. FIG. 1 shows a longitudinal cross-sectional view of a structure of a principal portion of the fuel injection valve 10. In the following explanation, a direction, in which a central axis of the fuel injection valve 10 extends (that is, an up-down direction in FIG. 1), is defined as an axial direction, and a direction, which extends radially from the axis, is defined as a radial direction. Furthermore, a direction, which extends circumferentially about the axis, is defined as a circumferential direction. In FIG. 1, an upper side is a base end side (an upstream side) of the fuel injection valve 10, and a lower side is a distal end side (a downstream side).

The fuel injection valve 10 includes a housing 11. The housing 11 is formed in a tubular shape and has a fuel passage 12 therein. The housing 11 is made of a magnetic material, and a non-magnetic portion 11a, which is made of a non-magnetic material, is interposed at an axial intermediate portion of the housing 11. The housing 11 has a hollow portion formed in a cylindrical shape, and the fuel passage 12 is formed by the hollow portion so as to extend in the axial direction. The gas fuel is supplied to the fuel passage 12 from an axial base end side (the upper side in the drawing). In a case where hydrogen gas is used as the gas fuel, the gas fuel compressed to about 3 MPa is supplied from a fuel supply portion, which is disposed on the upstream side, to the fuel passage 12.

The housing 11 has a partition wall 13 that partitions the fuel passage 12 into an upstream side and a downstream side. The housing 11 also has an end plate portion 14 at an axial distal end portion of the housing 11. A fuel chamber 15 is provided between the partition wall 13 and the end plate portion 14 in the housing 11. The fuel injection valve 10 is assembled to the gas engine such that the end plate portion 14 is exposed in the engine combustion chamber. The end plate portion 14 is not necessarily required to have a flat plate shape, which extends in a direction perpendicular to the axial direction as illustrated, and may have, for example, a conical shape that is convex toward the distal end side.

A plurality of communication holes 13a, each of which communicates between the upstream side and the downstream side of the partition wall 13, extend through the partition wall 13. The communication holes 13a are arranged in the circumferential direction at the partition wall 13. A shape of an opening of each communication hole 13a may be any shape and may be an arcuate shape extending in the circumferential direction or may be a circular shape. Further, an injection hole 14a, through which the gas fuel is injected into the engine combustion chamber, extends through the end plate portion 14 at a downstream end portion of the fuel passage 12. The injection hole 14a is provided at a center of the end plate portion 14.

The housing 11 serves as a main body, and the partition wall 13 serves as a partition. Furthermore, each of the communication holes 13a serves as an upstream-side opening, and the injection hole 14a serves as a downstream-side opening.

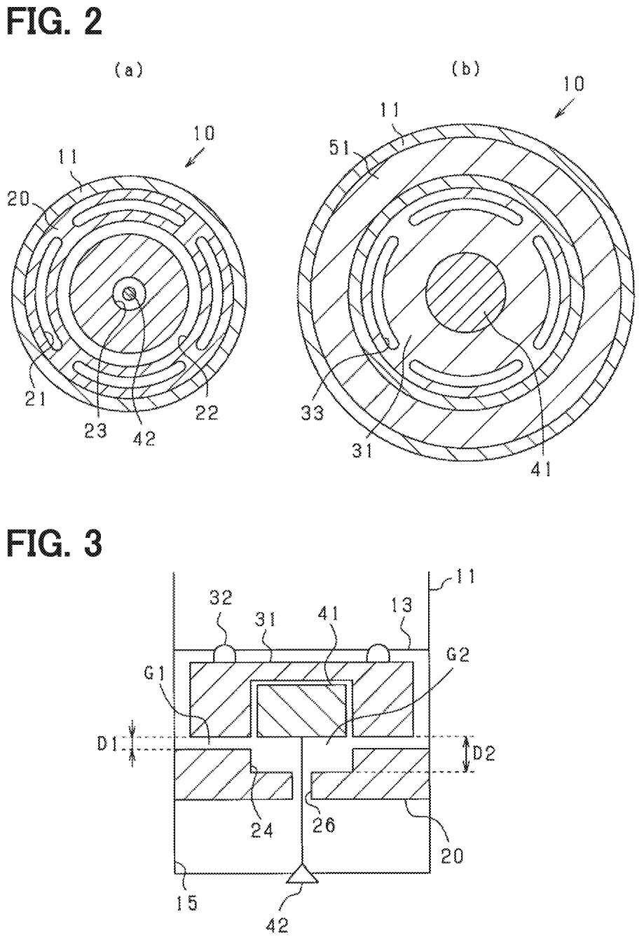

In the housing 11, a stationary core 20 is fixed between the partition wall 13 and the end plate portion 14, i.e., in the fuel chamber 15. The stationary core 20 is made of a magnetic material. The stationary core 20 has a plurality of communication passages 21 that communicate between an upstream side and a downstream side of the stationary core 20. In the fuel chamber 15, the flow of the gas fuel from the upstream side to the downstream side of the stationary core 20 is enabled through the communication passages 21. In FIG. 2, (a) is a cross-sectional view taken along line 2a-2a in FIG. 1. As shown in this cross-sectional view, the stationary core 20 has the plurality of communication passages 21 which are respectively formed in an arcuate shape and are arranged in the circumferential direction. Here, it should be noted that a shape of an opening of each communication passage 21 may be any shape.

A first valve 30, which opens and closes the communication holes 13a, and a second valve 40, which opens and closes the injection hole 14a, are provided in the fuel chamber 15. Each of the valves 30, 40 is reciprocally movable in the axial direction, and a direction, in which the first valve 30 opens the communication holes 13a (a valve opening direction of the first valve 30), is the same as a direction, in which the second valve 40 opens the injection hole 14a (a valve opening direction of the second valve 40). The valve opening direction of each of the valves 30, 40 is a downward direction in FIG. 1.

The first valve 30 includes a first movable core 31, which is made of a magnetic material, and a seal member 32, which is provided on a surface of the first movable core 31 opposed to the partition wall 13. In the first valve 30, the first movable core 31 is opposed to the stationary core 20. The injection hole 14a is opened by moving the first movable core 31 toward the stationary core 20.

The first movable core 31 is reciprocally movable in the axial direction in the fuel chamber 15 along an inner peripheral surface of the housing 11. The first movable core 31 has a plurality of communication passages 33 that communicate through the first movable core 31 in the axial direction. In FIG. 2, (b) is a cross-sectional view taken along line 2b-2b in FIG. 1. As shown in this cross-sectional view, the first movable core 31 has the plurality of communication passages 33 which are respectively formed in the arcuate shape and are arranged in the circumferential direction. It is preferable that each of the communication passages 33 is provided at a position where the communication passage 33 is continuous in the axial direction relative to a corresponding one of the communication passages 21 of the stationary core 20.

The seal member 32 is formed in a circular ring shape and is attached to an upstream-side end surface of the first movable core 31 at a location that is opposed to the communication holes 13a of the partition wall 13. In this case, when the seal member 32 is in contact with the partition wall 13, the communication holes 13a are closed to limit the flow of the fuel from the upstream side to the downstream side through the communication holes 13a. Furthermore, when the seal member 32 is spaced away from the partition wall 13, the communication holes 13a are opened to enable the flow of the fuel from the upstream side to the downstream side through the communication holes 13a. In the first valve 30, the seal member 32 functions as a valve member. The seal member 32 is made of any of elastic materials having elasticity, such as a rubber material, a resin material, or an elastomer material. More specifically, it is preferable to use, as a seal material of the seal member 32, fluoro rubber or EPDM (ethylene propylene diene monomer) rubber.

The first movable core 31 is arranged such that an upstream-side end surface of the first movable core 31 is opposed to the partition wall 13 in the axial direction, and a downstream-side end surface of the first movable core 31 is opposed to the stationary core 20 in the axial direction. The downstream-side end surface of the first movable core 31 and an upstream-side end surface of the stationary core 20 are opposed to each other in a state where the downstream-side end surface of the first movable core 31 and the upstream-side end surface of the stationary core 20 are parallel to each other. A first spring 34 made of a compression coil spring is disposed between the first movable core 31 and the stationary core 20. The first spring 34 urges the first movable core 31 toward a side away from the stationary core 20, that is, toward a side where the seal member 32 closes the communication holes 13a (a valve closing side of the first valve 30). A spring receiving portion 22, which is formed in a circular ring groove shape, is formed in the stationary core 20, and the first spring 34 is provided in a state where the first spring 34 is received in the spring receiving portion 22. Accordingly, the first movable core 31 is held in a state where the downstream-side end surface of the first movable core 31 is spaced away from the upstream-side end surface of the stationary core 20.

In the first valve 30, since the first movable core 31 is urged toward the valve closing side by the first spring 34, the communication holes 13a of the partition wall 13 are closed by the seal member 32, and an air gap is formed between the first movable core 31 and the stationary core 20.

The second valve 40 includes a second movable core 41, which is made of a magnetic material, and a valve element 42, which is moved integrally with the second movable core 41. In the second valve 40, the second movable core 41 is opposed to the stationary core 20. When the second movable core 41 is moved toward the stationary core 20, the injection hole 14a is opened. The second valve 40 is an outward-opening valve that becomes a valve opening state when the valve element 42 is moved toward the housing outside (i.e., the outside of the housing 11).

The valve element 42 is formed in a needle shape and extends in the axial direction from a downstream-side end surface of the second movable core 41. The valve element 42 is arranged in a state where the valve element 42 is inserted through an insertion hole 26 of the stationary core 20. With respect to the first valve 30 and the second valve 40, in the first valve 30, the seal member 32, which serves as the valve member, is provided on the upstream side of the first movable core 31, whereas in the second valve 40, the valve element 42, which serves as a valve member, is provided on the downstream side of the second movable core 41.

The second movable core 41 is provided on the upstream side of the stationary core 20 in a state where the second movable core 41 is received in a recess 35 of the first movable core 31. Accordingly, the second movable core 41 is movable integrally with the first movable core 31 toward the valve opening side (the lower side in FIG. 1). The first movable core 31 is formed in a bottomed tubular shape and has a hollow portion inside the first movable core 31, and the second movable core 41 is received in the hollow portion in a state in which the second movable core 41 is movable in the hollow portion.

More specifically, the recess 35 is recessed in the downstream-side end surface of the first movable core 31 at a center portion thereof that is centered in a transverse cross section of the first movable core 31, and the second movable core 41 is received in the recess 35 in a state where the second movable core 41 is reciprocally movable in the axial direction relative to the first movable core 31. Both the recess 35 of the first movable core 31 and the second movable core 41 have a circular shape in a cross section thereof, and the second movable core 41 is received inside the first movable core 31 which has a circular ring shape. In this case, the upstream-side end surface of the second movable core 41 is opposed to a bottom (an axial end surface) of the recess 35. When the first movable core 31 is moved toward the valve opening side, the first movable core 31 abuts against the second movable core 41, and thereafter the first movable core 31 and the second movable core 41 are moved together toward the valve opening side.

The first movable core 31 has a through hole 36 that extends through the first movable core 31 in the axial direction and is communicated with the recess 35. Accordingly, in a state where the first movable core 31 is moved toward the valve opening side, and the communication holes 13a of the partition wall 13 are opened, inflow of the gas fuel toward the rear surface of the second movable core 41 is enabled. In the first movable core 31, the through hole 36 has a reduced diameter that is reduced in comparison to that of the recess 35, and a step portion, which is formed by the recess 35 and the through hole 36, serves as a contact portion 37 that contacts the second movable core 41 when the first movable core 31 and the second movable core 41 are moved together.

A non-magnetic portion 43, which is formed in a sheet shape and is made of a non-magnetic material, is provided on the upstream-side end surface of the second movable core 41. It is only required that the non-magnetic portion 43 is located between the bottom surface of the recess 35 of the first movable core 31 and the second movable core 41 and is provided to at least one of the bottom surface of the recess 35 of the first movable core 31 and the second movable core 41.

The valve element 42 has a distal end valve portion 44 at an axial distal end portion of the valve element 42. The valve element 42 is arranged in a state where the valve element 42 is inserted through the injection hole 14a, and the distal end valve portion 44 closes the injection hole 14a from the housing outside. In this case, the injection hole 14a is opened when the distal end valve portion 44 is moved away from the end plate portion 14. It is preferable that the valve element 42 is made of a metal material, a non-metal material, or another non-elastomer material having excellent heat resistance. In the case where the valve element 42 has the outward-opening valve structure, inflow of flame and combustion pressure from the engine combustion chamber into the injection valve is suppressed.

A second spring 45 made of a compression coil spring is disposed between the second movable core 41 and the stationary core 20. The second spring 45 urges the second movable core 41 toward a side away from the stationary core 20, that is, toward a side where the distal end valve portion 44 of the valve element 42 closes the injection hole 14a (a valve closing side of the second valve 40). A spring receiving portion 23 is formed in the stationary core 20 at a location that surrounds a shaft of the valve element 42, and the second spring 45 is provided in a state where the second spring 45 is received in the spring receiving portion 23.

Additionally, a recess 24 is recessed in the upstream-side end surface of the stationary core 20 at a center portion thereof that is centered in a transverse cross section of the stationary core 20. The recess 24 is provided at a location axially opposed to the second movable core 41 and is sized so as to be able to receive a distal end portion of the second movable core 41. A non-magnetic portion 25, which is formed in a circular ring shape and is made of a non-magnetic material, is provided on an inner peripheral surface of the recess 24 in the stationary core 20.

In the second valve 40, since the second movable core 41 is urged toward the valve closing side by the second spring 45, the injection hole 14a is closed by the distal end valve portion 44 of the valve element 42, and an air gap is formed between the second movable core 41 and a bottom surface of the recess 24 of the stationary core 20.

Both the first movable core 31 and the second movable core 41 are opposed to the stationary core 20 from the axial upstream side of the stationary core 20, but separation distances (air gap dimensions) of their respective air gaps differ, and this configuration will be further described with reference to FIG. 3. FIG. 3 is an explanatory diagram showing a relationship between the stationary core 20 and the respective movable cores 31, 41. In FIG. 3, illustration of the communication passages 21, 33 of the stationary core 20 and the first movable core 31 is omitted.

As shown in FIG. 3, an air gap G1 is formed between the downstream-side end surface of the first movable core 31 and the upstream-side end surface of the stationary core 20, and an air gap G2 is formed between the downstream-side end surface of the second movable core 41 and the upstream-side end surface (specifically, the bottom surface of the recess 24) of the stationary core 20. The separation distance D1 of the air gap G1 and the separation distance D2 of the air gap G2 are set to be D1<D2. In this case, the first movable core 31 can move in the axial direction by a maximum distance that is equal to the separation distance D1, and the second movable core 41 can move in the axial direction by a maximum distance that is equal to the separation distance D2.

In FIGS. 1 and 3, the downstream-side end surface of the first movable core 31 and the downstream-side end surface of the second movable core 41 are flush with each other in an initial state (non-operating state), but the structure is not limited to this configuration. For example, the downstream-side end surface of the second movable core 41 may be configured so as to be recessed deeper than the downstream-side end surface of the first movable core 31 toward the bottom side of the recess, or the downstream-side end surface of the second movable core 41 may be configured so as to protrude further outward of the recess than the downstream-side end surface of the first movable core 31. In any case, it is sufficient as long as the relationship between the separation distance D1 of the air gap G1 and the separation distance D2 of the air gap G2 satisfies D1<D2.

In the fuel injection valve 10, a solenoid coil 51 is provided at a location that surrounds the first movable core 31 and the stationary core 20. The solenoid coil 51 is provided at a position that overlaps, in the axial direction, the stationary core 20 and each of the movable cores 31, 41.

In addition to the fuel injection valve 10, the fuel injection system of the present embodiment includes: a drive circuit 53, which energizes the solenoid coil 51; and a controller 54, which controls the fuel injection of the fuel injection valve 10. In the fuel injection system, the drive circuit 53 is connected to the solenoid coil 51 via a harness 52. Energization by the drive circuit 53 is controlled by the controller 54. The controller 54 includes a microcomputer that has a CPU and various types of memory. During the engine operation, the controller 54 outputs an energization signal to the drive circuit 53 in accordance with a combustion cycle of each cylinder, thereby causing the fuel injection valve 10 to inject fuel.

In the fuel injection valve 10, magnetic energy is generated by energizing the solenoid coil 51 through the drive circuit 53, and the first movable core 31 and the second movable core 41 are attracted to the stationary core 20 by this magnetic energy. As a result, the first valve 30 and the second valve 40 are brought into the valve opening state, and the gas fuel is injected from the injection hole 14a. In the present embodiment, the two valves 30, 40 are driven to open simultaneously by the single solenoid coil 51.

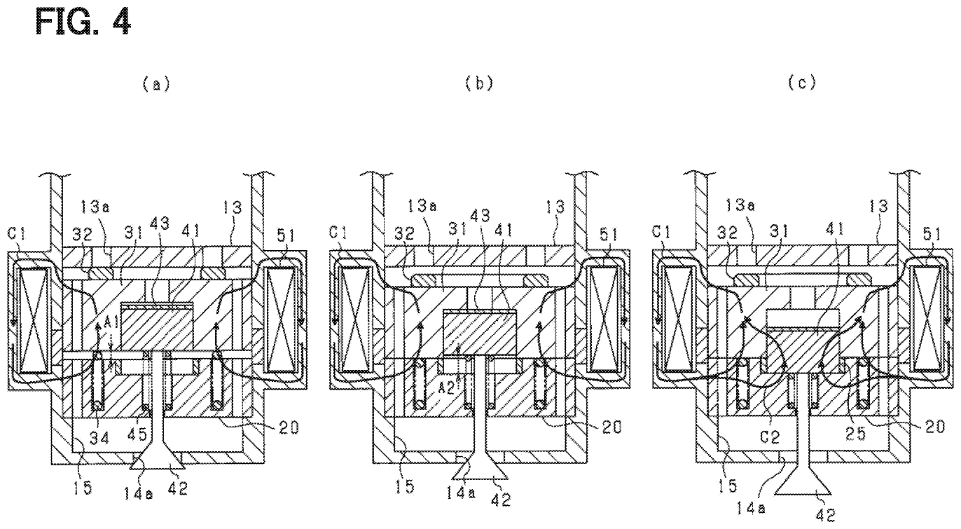

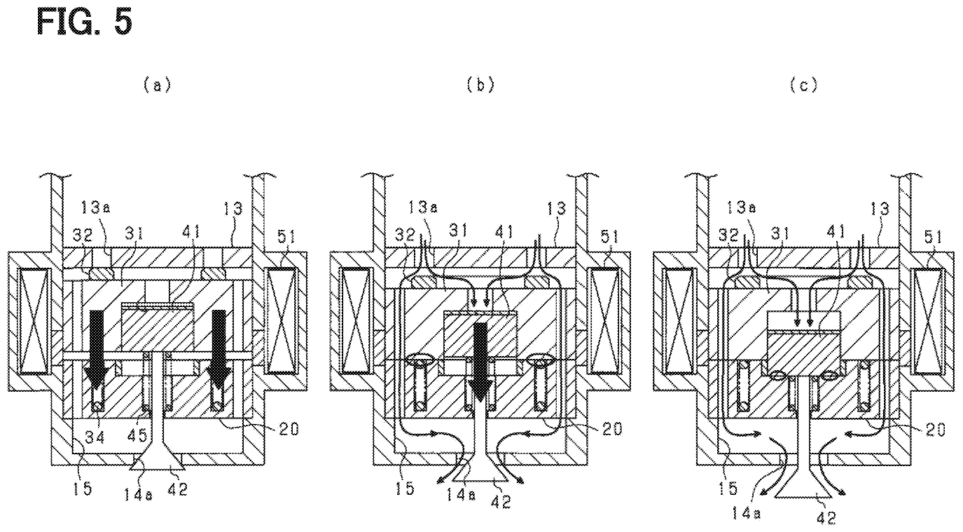

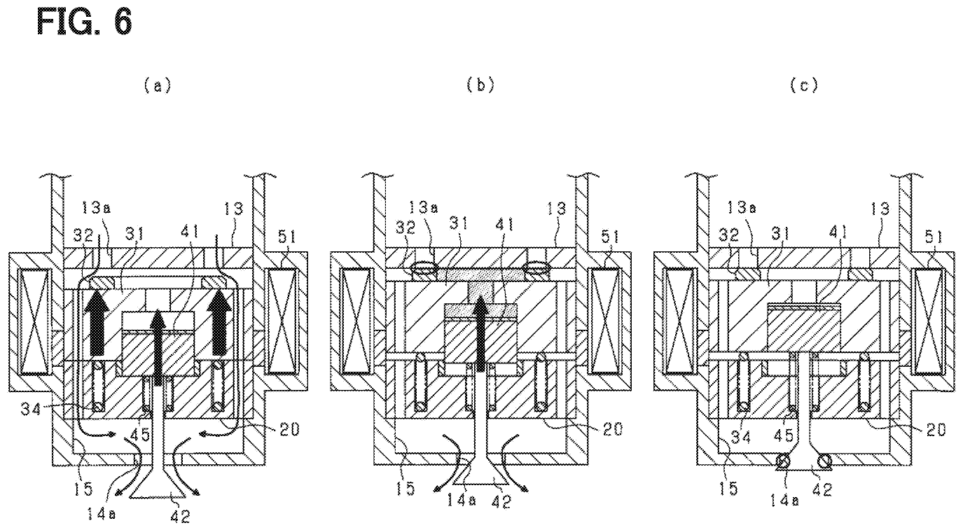

Next, the operations at the valve opening time and the valve closing time of the fuel injection valve 10 will be explained in detail. Here, (a) to (c) of FIG. 4 and (a) to (c) of FIG. 5 are diagrams for explaining the operation at the valve opening time of the fuel injection valve 10, and (a) to (c) of FIG. 6 are diagrams for explaining the operation at the valve closing time of the fuel injection valve 10.

First, the operation at the valve opening time of the fuel injection valve 10 will be explained with reference to (a) to (c) of FIG. 4. In (a) of FIG. 4, the energization to the solenoid coil 51 is started. As a result, a drive magnetic flux is generated, and a magnetic circuit is formed along a first magnetic flux path indicated by an arrow C1 in the drawing, and a magnetic attractive force is exerted between the first movable core 31 and the stationary core 20 to attract each other.

Then, as shown in (b) of FIG. 4, when the first movable core 31 is magnetically attracted to the stationary core 20, the second movable core 41 is moved together with the first movable core 31, and both the first valve 30 and the second valve 40 are opened. At this time, the separation distance D1 between the first movable core 31 and the stationary core 20 and the separation distance D2 between the second movable core 41 and the stationary core 20 are different from each other in the initial state (see FIG. 3). Then, in an initial stage of the energization of the solenoid coil 51, a magnetic circuit is formed through a path that passes through the first movable core 31 which has the smaller separation distance D1 relative to the stationary core 20 than the separation distance D2 of the second movable core 41 relative to the stationary core 20. As a result, in the initial stage of the energization, the magnetic flux flows intensively through the first magnetic flux path C1, which includes the first movable core 31, so that the valve opening responsiveness of the first valve 30 is increased.

Furthermore, in the fuel injection valve 10, the first movable core 31 is disposed inside the solenoid coil 51, and the second movable core 41 is disposed inside the first movable core 31. That is, the first movable core 31 is disposed on the radially outer side of the second movable core 41, that is, the first movable core 31 is disposed closer to the solenoid coil 51 than the second movable core 41. Therefore, at the initial stage of energization of the solenoid coil 51, a stronger magnetic attractive force is generated between the first movable core 31 and the stationary core 20 than between the second movable core 41 and the stationary core 20, thereby increasing the valve opening responsiveness of the first valve 30.

Further, the non-magnetic portion 43 is interposed between the surface of the first movable core 31 and the surface of the second movable core 41 which are opposed to each other in the axial direction. In the state shown in (a) of FIG. 4 and the state shown in (b) of FIG. 4, the non-magnetic portion 43 functions as a magnetic flux restricting portion that restricts the flow of the magnetic flux that passes through between the first movable core 31 and the second movable core 41. As a result, the passing of the magnetic flux through the unintended path is suppressed, and thereby the magnetic flux is caused to flow intensively through the first magnetic flux path C1.

In the state shown in (b) of FIG. 4, the first movable core 31 is brought into contact (seated) with the stationary core 20, and the separation distance between the second movable core 41 and the stationary core 20 is reduced relative to (a) of FIG. 4. Further, the second movable core 41 is moved together with the first movable core 31 toward the valve opening side until the first movable core 31 contacts the stationary core 20. After the first movable core 31 contacts the stationary core 20, the second movable core 41 moves alone toward the valve opening side due to its inertia. Therefore, the separation distance between the second movable core 41 and the stationary core 20 is reduced, and a magnetic circuit is formed by a second magnetic flux path indicated by an arrow C2 in addition to the first magnetic flux path indicated by the arrow C1, thereby generating a magnetic attractive force between the second movable core 41 and the stationary core 20 to attract each other.

As a result, as shown in (c) of FIG. 4, the second movable core 41 is magnetically attracted to the stationary core 20, and the second movable core 41 is seated on the stationary core 20. In this state, both the first movable core 31 and the second movable core 41 are seated on the stationary core 20, and the opening degree of the injection hole 14a by the valve element 42 of the second valve 40 reaches a maximum opening degree. The state shown in (c) of FIG. 4 is maintained by continuing the energization of the solenoid coil 51.

The spring receiving portion 22, which is formed in the circular ring groove shape, is formed in the stationary core 20, and the first spring 34 is received in the spring receiving portion 22. Therefore, a radial wall thickness of a portion of the stationary core 20, which is opposed to the first movable core 31, is reduced to function as a magnetic constricted portion. In this case, magnetic saturation occurs at the magnetic constricted portion of the stationary core 20 (that is, the first magnetic flux path C1 passing through the first movable core 31 and the stationary core 20), so that the amount of magnetic flux in the second magnetic flux path C2 (bypass path), which passes through the second movable core 41 and the stationary core 20, is increased. As a result, the magnetic attraction of the second movable core 41 to the stationary core 20 is properly generated.

Further, in the state shown in (c) of FIG. 4, the non-magnetic portion 25 is interposed between the stationary core 20 and the second movable core 41, which are radially opposed to each other. The non-magnetic portion 25 functions as a magnetic flux restricting portion that restricts the flow of the magnetic flux that passes through in the radial direction between the stationary core 20 and the second movable core 41. As a result, an appropriate axial magnetic attractive force can be generated between the stationary core 20 and the second movable core 41.

With respect to (a) to (c) of FIG. 4, in (a) of FIG. 4, the first valve 30 and the second valve 40 are both in a valve closing position thereof, and in (b) of FIG. 4, the first valve 30 and the second valve 40 are moved to a first lift position. That is, the second valve 40 is moved together with the first valve 30 to the first lift position within the movement range of the first valve 30. Subsequently, as shown in (c) of FIG. 4, the second valve 40 is moved alone to a second lift position where the valve-element lift amount (i.e., the lift amount of the valve element 42) is larger than that of the first lift position.

As shown in (a) of FIG. 4, the amount of movement of the first movable core 31 at the time of magnetically attracting the first movable core 31 toward the stationary core 20 in response to the generation of the drive magnetic flux is A1, and as shown in (b) of FIG. 4, after the movement of the first movable core 31, the amount of movement of the second movable core 41 at the time of magnetically attracting the second movable core 41 alone toward the stationary core 20 after the movement of the first movable core 31 is A2. The amount of movement A1 and the amount of movement A2 have a relationship of A1<A2. In this case, since the amount of movement A1 of the first movable core 31 at the initial stage of energization is relatively small, the opening responsiveness of the first valve 30 at the initial stage of energization is increased. Furthermore, since the amount of movement A2 of the second movable core 41 alone is relatively large, the maximum opening degree of the second valve 40 can be increased while taking into account the movement of the first movable core 31 imparts inertial force to the second movable core 41.

Next, the flow of the gas fuel in the fuel injection valve 10 will be explained with reference to (a) to (c) of FIG. 5. It should be noted that each of the states respectively shown in (a) to (c) of FIG. 5 corresponds to the corresponding one of the states respectively shown in (a) to (c) of FIG. 4.

In (a) of FIG. 5, upon starting the energization of the solenoid coil 51, the first movable core 31 and the second movable core 41 are moved toward the valve opening side, and in (b) of FIG. 5, both the first valve 30 and the second valve 40 are held in the valve opening state. At this time, as the first valve 30 is brought into the valve opening state, the gas fuel flows from the communication holes 13a into the fuel chamber 15. Additionally, as the injection hole 14a is opened, fuel injection from the injection hole 14a is started. In the fuel chamber 15, the gas fuel, which flows into the fuel chamber 15 from communication holes 13a, flows to the downstream side of the stationary core 20 via each of the communication passages 33, 21 of the first movable core 31 and the stationary core 20 and also flows to the rear side of the second movable core 41 via the through hole 36 of the first movable core 31. At this time, the gas fuel, which flows to the rear side of the second movable core 41, urges the second movable core 41 toward the valve opening side, thereby assisting the movement of the second movable core 41 to the valve opening side.

In (c) of FIG. 5, the second valve 40 reaches its maximum opening degree, and the maximum opening degree of the second valve 40 is maintained by the energization of the solenoid coil 51. In this state, as the second movable core 41 is moved relative to the first movable core 31, a rear space on the rear side of the second movable core 41 is formed in the recess 35 of the first movable core 31, and the gas fuel is introduced into this rear space.

Next, the operation at the valve closing time of the fuel injection valve 10 will be explained with reference to (a) to (c) of FIG. 6. In (a) of FIG. 6, the first movable core 31 and the second movable core 41 are magnetically attracted to the stationary core 20 by the drive magnetic flux, that is, both the first valve 30 and the second valve 40 are in the valve opening state. In this state, when the energization of the solenoid coil 51 is stopped, the drive magnetic flux disappears. As a result, the magnetic attractive force between each of the movable cores 31, 41 and the stationary core 20 disappears, and the first movable core 31 and the second movable core 41 start moving toward the valve closing side by the urging forces of the first spring 34 and the second spring 45.

In the present embodiment, at the valve closing time of the fuel injection valve 10, due to the disappearance of the drive magnetic flux, the first valve 30 is returned to the valve closing position before the second valve 40 among the first valve 30 and the second valve 40, and the second valve 40 is returned to the valve closing position after the first valve 30 is returned to the valve closing position. Therefore, after the disappearance of the drive magnetic flux (after the energization of the solenoid coil 51 is stopped), as shown in (b) of FIG. 6, a state, in which the first valve 30 is in the valve closing state, and the second valve 40 is not in the valve closing state, occurs temporarily, and under this state, the gas fuel in the fuel chamber 15 flows out through the injection hole 14a. In this case, the communication holes 13a, which are the upstream-side openings, are closed before the injection hole 14a, which is the downstream-side opening. Therefore, the supply of the gas fuel from the upstream side is quickly stopped after the energization of the solenoid coil 51 is stopped, and the pressure in the fuel chamber 15 is quickly reduced by the outflow of the gas fuel through the injection hole 14a.

In (b) of FIG. 6, as the first valve 30 transitions from the valve opening state to the valve closing state, the space at the rear side of the second movable core 41 becomes a closed space (a dotted area in (b) of FIG. 6). Therefore, after the first valve 30 is closed, the movement of the second movable core 41 (the second valve 40) toward the valve closing side is prevented by the gas fuel, which remains in the closed space at the rear side of the second movable core 41. As a result, after the disappearance of the drive magnetic flux, the valve closing operation of the second valve 40 is delayed, and the outflow of the gas fuel from the fuel chamber 15 through the injection hole 14a is performed rapidly. It should be noted that the gas fuel in the closed space is gradually released through, for example, a gap between the first movable core 31 and the second movable core 41.

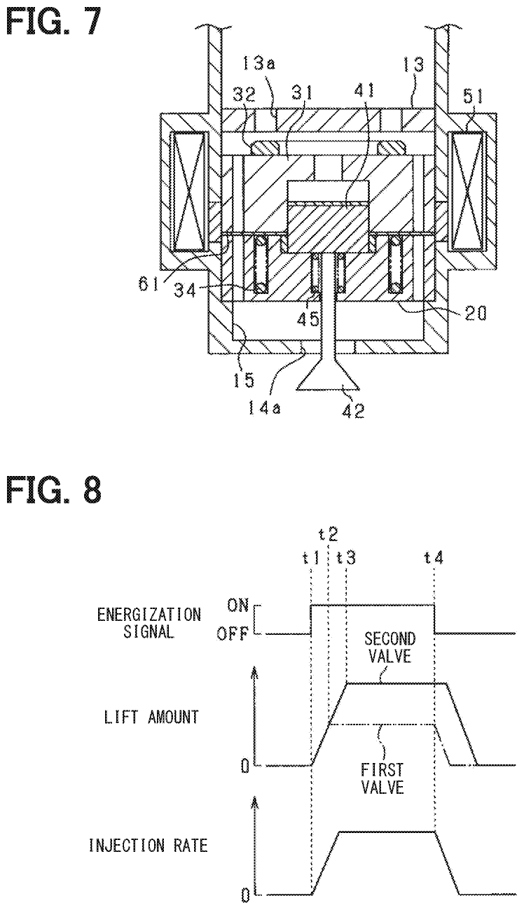

As shown in FIG. 7, in a state in which the first movable core 31 and the second movable core 41 are magnetically attracted to the stationary core 20 by the drive magnetic flux (corresponding to the state of (a) of FIG. 6), it is preferable that the separation distance between the first movable core 31 and the stationary core 20 is larger than the separation distance between the second movable core 41 and the stationary core 20. Specifically, a spacer 61, which is formed in a plate shape and is made of a non-magnetic material, is interposed between the surface of the first movable core 31 and the surface of the stationary core 20, which are opposed to each other. With this spacer 61, a solid gap is formed between the first movable core 31 and the stationary core 20. In this case, when the first valve 30 and the second valve 40 are moved toward the valve closing side in response to the disappearance of the drive magnetic flux, the first movable core 31 becomes easier to separate from the stationary core 20 than the second movable core 41.

Subsequently, in (c) of FIG. 6, the second movable core 41 is returned to the valve closing position by the urging force of the second spring 45, and the second valve 40 comes into the valve closing state. As a result, the fuel injection is stopped. At this time, the pressure in the fuel chamber 15 acts as an urging force toward the valve opening side on the second valve 40, while the urging force of the second spring 45 and the pressure in the engine combustion chamber (hereinafter referred to as an in-cylinder pressure) act as an urging force toward the valve closing side on the second valve 40. When the pressure in the fuel chamber 15 is reduced below the valve closing force, which is exerted by the urging force of the second spring 45 and the in-cylinder pressure, the valve element 42 is placed in the valve closing state.

FIG. 8 is a time chart showing changes in the lift amount and changes in the injection rate of the first valve 30 and the second valve 40 during the opening and closing of the fuel injection valve 10. Note that the energization signal is an injection-valve control signal (serving as an energization command) outputted from the controller 54. When the energization signal is turned on, the solenoid coil 51 is energized. When the energization signal is turned off, the energization of the solenoid coil 51 is stopped. The injection rate is the amount of fuel injected per unit time. In FIG. 8, the lift amount of each valve 30, 40 is shown. Specifically, the lift amount of the first valve 30 is indicated by a dot-dash line, and the lift amount of the second valve 40 is indicated by a solid line.

In FIG. 8, at timing t1, the energization of the solenoid coil 51 is started by turning on the energization signal. In response to the start of the energization, the lifts of the first valve 30 and the second valve 40 are started. At the initial stage of energization, the first valve 30 and the second valve 40 are moved together, so the lift amounts of these valves 30, 40 are identical. As the lift amounts of the valves 30, 40 increase, the injection rate gradually increases.

Subsequently, at timing t2, the first movable core 31 contacts the stationary core 20, so that the first valve 30 is stopped at the first lift position. After the timing t2, the second valve 40 is lifted alone, and only the lift amount of the second valve 40 increases.

At timing t3, the second movable core 41 contacts the stationary core 20, so that the second valve 40 is stopped at the second lift position. In this case, the second valve 40 is lifted in two stages, so that it is possible to increase the maximum opening degree of the injection hole 14a and thereby increase the injection rate.

Subsequently, at timing t4, the energization of the solenoid coil 51 is stopped by turning off the energization signal. At this time, the first valve 30 returns to the valve closing position immediately after the disappearance of the drive magnetic flux, whereas the second valve 40 returns to the valve closing position after a delay from the time of the disappearance of the drive magnetic flux. That is, the first valve 30 is first returned to the valve closing position by the urging force of the first spring 34, and the second valve 40 is returned to the valve closing position by the urging force of the second spring 45 after the first valve 30 is returned to the valve closing position.

In this case, the communication holes 13a, which are the upstream-side openings, are closed first, so that the fuel supply from the upstream side is quickly stopped after the energization of the solenoid coil 51 is stopped, and the pressure drop in the fuel chamber 15 is accelerated. As a result, after the energization signal is turned off, the decrease in the injection rate is accelerated, and the injection cut-off becomes satisfactory.

The embodiment described above can achieve the following advantages.

In the fuel injection valve 10, the second valve 40, which opens and closes the injection hole 14a, is moved together with the first valve 30 toward the valve opening side at the initial stage of valve opening by the magnetic attraction of the first movable core 31 to the stationary core 20, and subsequently the second valve 40 is moved alone further toward the valve opening side by the magnetic attraction of the second movable core 41 to the stationary core 20. That is, the second valve 40 performs the valve opening operation with high responsiveness, as the first movable core 31 and the second movable core 41 are magnetically attracted stepwise. Further, the second valve 40 is lifted in the two stages, so that it is possible to increase the maximum opening degree of the injection hole 14a as compared with lifting in the single-stage, and therefore achieve a large flow rate of the gas fuel having a large fuel volume. In this case, if an attempt is made to increase the maximum opening degree of the injection hole 14a with the lifting in the single-stage, there is a concern that disadvantages, such as the need to increase the size of the solenoid coil 51 for generating the drive magnetic flux, will arise. However, according to the present embodiment, such disadvantages can be suppressed. As a result, it is possible to increase the responsiveness at the time of fuel injection and achieve a large flow rate of the gas fuel.

Upon the generation of the drive magnetic flux, the magnetic saturation occurs in the first magnetic flux path C1 that passes through the first movable core 31 and the stationary core 20 to increase the amount of the magnetic flux of the second magnetic flux path C2 which passes through the second movable core 41 and the stationary core 20. As a result, at the initial stage of energization of the solenoid coil 51, the magnetic attraction of the first movable core 31, that is, the valve opening of the first valve 30, can be performed with good responsiveness, and subsequently, the magnetic attraction of the second movable core 41, that is, the increase in the lift amount of the second valve 40, can be properly performed.

The second movable core 41 is received in the movable state within the hollow portion of the first movable core 31, and the solenoid coil 51 is provided so as to surround the first movable core 31 and the stationary core 20. In this case, the first movable core 31 is disposed inside the solenoid coil 51, and the second movable core 41 is disposed inside the first movable core 31. Therefore, at the initial stage of energization of the solenoid coil 51, a stronger magnetic attractive force is generated between the first movable core 31 and the stationary core 20 than between the second movable core 41 and the stationary core 20, thereby increasing the valve opening responsiveness of the first valve 30.

The amount of movement of the first movable core 31 at the time of magnetically attracting the first movable core 31 toward the stationary core 20 in response to the generation of the drive magnetic flux is smaller than the amount of movement of the second movable core 41 at the time of magnetically attracting the second movable core 41 alone toward the stationary core 20 after the movement of the first movable core 31. In this case, at the initial stage of energization of the solenoid coil 51, the opening responsiveness of the first valve 30 can be increased, and, at the time of the subsequent valve opening of the second valve 40, the appropriate valve opening operation can be performed by using the inertial force imparted by the valve opening operation of the first valve 30.

At the time of valve closing of the fuel injection valve 10 from the valve opening state (that is, the state in which the first movable core 31 and the second movable core 41 are magnetically attracted to the stationary core 20 by the drive magnetic flux), the communication holes 13a of the partition wall 13 are first closed by the first valve 30, and subsequently the injection hole 14a is closed by the second valve 40. In this case, among the communication holes 13a, which are the upstream-side openings, and the injection hole 14a, which is the downstream-side opening, the communication holes 13a are closed first, so that the fuel supply from the upstream side is quickly stopped after the energization of the solenoid coil 51 is stopped, and the pressure drop in the fuel chamber 15 is accelerated. As a result, it is possible to improve the injection cut-off performance at the end of energization of the fuel injection valve 10.

In the fuel injection valve 10, in the valve opening state of the first valve 30, the gas fuel flows into the rear space, which faces the side opposite to the valve element 42 of the second movable core 41. As a result, the gas fuel, which flows into the rear space, urges the second movable core 41 (second valve 40) toward the valve opening side. Therefore, at the initial stage of valve opening of the second valve 40, the movement of the second movable core 41 toward the valve opening side can be assisted. Furthermore, by shifting the first valve 30 from the valve opening state to the valve closing state, the rear space is closed by the first valve 30 and thereby becomes the closed space. As a result, after closing of the first valve 30, the gas fuel, which remains in the closed space (rear space), acts as an obstacle when the second movable core 41 (second valve 40) returns toward the valve closing side. Therefore, after the energization of the solenoid coil 51 is stopped, the outflow of the gas fuel from the fuel chamber 15 through the injection hole 14a can be quickly performed, and, consequently, the injection cut-off performance at the end of fuel injection can be improved.

In the valve opening state of the fuel injection valve 10, the separation distance between the first movable core 31 and the stationary core 20 is larger than the separation distance between the second movable core 41 and the stationary core 20 (see FIG. 7). In this case, when the first valve 30 and the second valve 40 are moved toward the valve closing side in response to the disappearance of the drive magnetic flux, the first movable core 31 becomes easier to separate from the stationary core 20 than the second movable core 41. Therefore, it is possible to suitably realize the configuration in which the communication holes 13a are closed first among the communication holes 13a and the injection hole 14a.

### Other Embodiments

The above embodiment may be modified, for example, as follows.

In the above embodiment, the amount of movement A1 of the first movable core 31 at the time of magnetically attracting the first movable core 31 toward the stationary core 20 in response to the generation of the drive magnetic flux, and the amount of movement A2 of the second movable core 41 at the time of magnetically attracting the second movable core 41 alone toward the stationary core 20 after the movement of the first movable core 31 are set to have the relationship of A1<A2. This relationship may be changed. The relationship between the amount of movement A1 and the amount of movement A2 may be set to A1=A2 or A1>A2.

In the above embodiment, the first movable core 31 is formed in the bottomed tubular shape and has the hollow portion inside the first movable core 31, and the circular ring portion and the contact portion 37 are made of the magnetic material. However, this may be changed such that a contact plate, which serves as a contact portion and is made of a non-magnetic material, is provided at an axial end portion of the circular ring portion of the first movable core 31.

Technical aspects, which are obtained based on the embodiments described above, will be recited below.

### Configuration 1

According to configuration 1, there is provided a gas fuel injection valve (10) that is configured to inject a gas fuel, the gas fuel injection valve including:
a main body (11) that has:
   a fuel passage (12) which is configured to conduct the gas fuel;
   an upstream-side opening (13a) which is formed through a partition (13) that partitions the fuel passage into an upstream side and a downstream side; and
   a downstream-side opening (14a) which is formed at a downstream end portion of the fuel passage;
a stationary core (20) that is fixed to the main body;
a first valve (30) that includes a first movable core (31) which is opposed to the stationary core, wherein the first valve is configured to open and close the upstream-side opening by movement of the first movable core; and
a second valve (40) that includes a second movable core (41) which is opposed to the stationary core, wherein the second valve is configured to open and close the downstream-side opening by movement of the second movable core, wherein:
the first valve and the second valve are configured to be moved together toward a valve opening side when the first movable core is magnetically attracted to the stationary core in response to generation of a drive magnetic flux; and
after the first valve stops at a first lift position, the second movable core is magnetically attracted to the stationary core by the drive magnetic flux, and thereby the second valve is moved from the first lift position to a second lift position at which a valve-element lift amount of the second valve is larger than a valve-element lift amount of the second valve measured at the first lift position.

### Configuration 2

According to configuration 2, there is provided the gas fuel injection valve according to configuration 1, wherein upon the generation of the drive magnetic flux, magnetic saturation occurs in a first magnetic flux path that passes through the first movable core and the stationary core to increase an amount of a magnetic flux of a second magnetic flux path which passes through the second movable core and the stationary core.

### Configuration 3

According to configuration 3, there is provided the gas fuel injection valve according to configuration 1 or 2, wherein:
the first movable core is formed in a tubular shape and has a hollow portion inside the first movable core, and the second movable core is received in the hollow portion in a state in which the second movable core is movable in the hollow portion; and
a solenoid coil (51), which is configured to generate the drive magnetic flux, is arranged to surround the first movable core and the stationary core.

### Configuration 4

According to configuration 4, there is provided the gas fuel injection valve according to any one of configurations 1 to 3, wherein an amount of movement of the first movable core, which is generated when the first movable core is magnetically attracted to the stationary core in response to the generation of the drive magnetic flux, is smaller than an amount of movement of the second movable core, which is generated when the second movable core is magnetically attracted to the stationary core after the movement of the first movable core.

### Configuration 5

According to configuration 5, there is provided the gas fuel injection valve according to any one of configurations 1 to 4, including:
a first spring (34) that is configured to urge the first valve toward a valve closing side of the first valve; and
a second spring (45) that is configured to urge the second valve toward a valve closing side of the second valve, wherein:
when the drive magnetic flux disappears in a state in which the first movable core and the second movable core are magnetically attracted to the stationary core by the drive magnetic flux, the first valve is returned to a valve closing position of the first valve by an urging force of the first spring earlier than the second valve, and then the second valve is returned to a valve closing position of the second valve by an urging force of the second spring after the first valve is returned to the valve closing position of the first valve.

### Configuration 6

According to configuration 3, there is provided the gas fuel injection valve according to configuration 5, wherein:
the first movable core is formed in a tubular shape and has a hollow portion inside the first movable core, and the second movable core is received in the hollow portion in a state in which the second movable core is movable in the hollow portion;
the second valve is an outward-opening valve that is placed in a valve opening state when a valve element (42) of the second valve, which is formed integrally with the second movable core, is moved toward an outside of the main body; and
in a valve opening state of the first valve, the gas fuel flows into a rear space, which communicates with the hollow portion and faces a side of the second movable core opposite to the valve element, and when the first valve is displaced from the valve opening state to a valve closing state, the rear space becomes a closed space which is closed by the first valve.

### Configuration 7

According to configuration 7, there is provided the gas fuel injection valve according to configuration 5 or 6, wherein in a state in which the first movable core and the second movable core are magnetically attracted to the stationary core by the drive magnetic flux, a separation distance between the first movable core and the stationary core is larger than a separation distance between the second movable core and the stationary core.

Although the present disclosure has been described with reference to the embodiments and the modifications, it is understood that the present disclosure is not limited to the embodiments and the modifications and structures described therein. The present disclosure also encompasses various modifications and changes within the scope of equivalents. Also, various combinations and forms, as well as other combinations and forms that include only one element, more, or less, are within the scope and ideology of the present disclosure.

What is claimed is:

1. A gas fuel injection valve that is configured to inject a gas fuel, the gas fuel injection valve comprising:
a main body that has:
a fuel passage which is configured to conduct the gas fuel;
an upstream-side opening which is formed through a partition that partitions the fuel passage into an upstream side and a downstream side; and
a downstream-side opening which is formed at a downstream end portion of the fuel passage;
a stationary core that is fixed to the main body;
a first valve that includes a first movable core which is opposed to the stationary core, wherein the first valve is configured to open and close the upstream-side opening by movement of the first movable core; and
a second valve that includes a second movable core which is opposed to the stationary core, wherein the second valve is configured to open and close the downstream-side opening by movement of the second movable core, wherein:
the first valve and the second valve are configured to be moved together toward a valve opening side when the first movable core is magnetically attracted to the stationary core in response to generation of a drive magnetic flux; and
after the first valve stops at a first lift position, the second movable core is magnetically attracted to the stationary core by the drive magnetic flux, and thereby the second valve is moved from the first lift position to a second lift position at which a valve-element lift amount of the second valve is larger than a valve-element lift amount of the second valve measured at the first lift position.

2. The gas fuel injection valve according to claim 1, wherein upon the generation of the drive magnetic flux, magnetic saturation occurs in a first magnetic flux path that passes through the first movable core and the stationary core to increase an amount of a magnetic flux of a second magnetic flux path which passes through the second movable core and the stationary core.

3. The gas fuel injection valve according to claim 1, wherein:
the first movable core is formed in a tubular shape and has a hollow portion inside the first movable core, and the second movable core is received in the hollow portion in a state in which the second movable core is movable in the hollow portion; and
a solenoid coil, which is configured to generate the drive magnetic flux, is arranged to surround the first movable core and the stationary core.

4. The gas fuel injection valve according to claim 1, wherein an amount of movement of the first movable core, which is generated when the first movable core is magnetically attracted to the stationary core in response to the generation of the drive magnetic flux, is smaller than an amount of movement of the second movable core, which is generated when the second movable core is magnetically attracted to the stationary core after the movement of the first movable core.

5. The gas fuel injection valve according to claim 1, comprising:
a first spring that is configured to urge the first valve toward a valve closing side of the first valve; and
a second spring that is configured to urge the second valve toward a valve closing side of the second valve, wherein:
when the drive magnetic flux disappears in a state in which the first movable core and the second movable core are magnetically attracted to the stationary core by the drive magnetic flux, the first valve is returned to a valve closing position of the first valve by an urging force of the first spring earlier than the second valve, and then the second valve is returned to a valve closing position of the second valve by an urging force of the second spring after the first valve is returned to the valve closing position of the first valve.

6. The gas fuel injection valve according to claim 5, wherein:
the first movable core is formed in a tubular shape and has a hollow portion inside the first movable core, and the second movable core is received in the hollow portion in a state in which the second movable core is movable in the hollow portion;
the second valve is an outward-opening valve that is placed in a valve opening state when a valve element of the second valve, which is formed integrally with the second movable core, is moved toward an outside of the main body; and
in a valve opening state of the first valve, the gas fuel flows into a rear space, which communicates with the hollow portion and faces a side of the second movable core opposite to the valve element, and when the first valve is displaced from the valve opening state to a valve closing state, the rear space becomes a closed space which is closed by the first valve.

7. The gas fuel injection valve according to claim 5, wherein in a state in which the first movable core and the second movable core are magnetically attracted to the stationary core by the drive magnetic flux, a separation distance between the first movable core and the stationary core is larger than a separation distance between the second movable core and the stationary core.
